(19) United States
(12) Patent Application Publication
(10) Pub. No.: US 2018/0015677 A1
(43) Pub. Date: Jan. 18, 2018

(54) Method for Exchanging a Section of a Plastic Component

(71) Applicant: Bayerische Motoren Werke Aktiengesellschaft, Muenchen (DE)

(72) Inventors: Clemens STEFANZIOSA, Muenchen (DE); Wolfgang HAHN, Petershausen (DE); Johann VAN NIEKERK, Muenchen (DE); Maik HAMMER, Bruckberg (DE)

(21) Appl. No.: 15/715,358

(22) Filed: Sep. 26, 2017

Related U.S. Application Data
(63) Continuation of application No. PCT/EP2016/062217, filed on May 31, 2016.

(30) Foreign Application Priority Data
Jun. 15, 2015 (DE) 10 2015 210 869.4

(51) Int. Cl. B29C 73/12; B29C 65/56; B29C 65/72; B29C 65/00; B29C 65/08; B29L 31/00; B29C 73/26; B29L 31/30; B29L 31/54

(52) U.S. Cl. CPC B29C 73/12; B29C 66/721; B29C 65/562; B29C 65/72; B29C 66/1222; B29C 66/1224; B29C 66/21; B29C 66/7212; B29C 65/085; B29C 66/53245; B29C 2073/264; B29C 2793/0018; B29C 2793/0081; B29L 2031/30; B29L 2031/54; B29L 2031/7734

(57) ABSTRACT

A method is provided for exchanging a section, in particular a damaged section, of a plastic component. The method includes: separating the section from the plastic component; providing at least one connecting element made from a plastic; pressing the at least one connecting element onto the plastic component such that the one connecting element abuts a remaining part of the plastic component; oscillating the connecting element by an ultrasonic sonotrode; and welding the connecting element to the remaining part of the plastic component; providing a replacement section for the separated section, wherein the replacement section has a hole, in particular a through-hole; applying the replacement section in the region from which the separated section was separated, such that the replacement section is clamped by its hole directly in a form-fitting and/or force-fitting manner onto the connecting element and/or the connecting element extends at least some way through the through-hole, wherein a clip element is clipped onto a section of the connecting element extending through the hole. The clip element projects beyond the through-hole and connects the replacement part to the remaining part of the plastic component in a form-fitting and/or force-fitting manner.

### CROSS REFERENCE TO RELATED APPLICATIONS

This application is a continuation of PCT International Application No. PCT/EP2016/062217, filed May 31, 2016, which claims priority under 35 U.S.C. §119 from German Patent Application No. 10 2015 210 869.4, filed Jun. 15, 2015, the entire disclosures of which are herein expressly incorporated by reference.

### BACKGROUND AND SUMMARY OF THE INVENTION

The present invention relates to a method for exchanging a section of a plastic component, in particular a damaged section of a plastic component.

A method of this kind is known from DE 10 2013 203 208 A1.

It is the object of the invention to provide an alternative method for exchanging a section of a plastic component that is easy to carry out.

This and other objects are achieved by a method for exchanging a section, in particular a damaged section, of a plastic component, characterized by the following acts: the section is separated from the plastic component; at least one connection element made from a plastic is provided; the at least one connection element is pressed against the plastic component such that the at least one connection element comes to bear against a remaining part of the plastic component; the connection element is made to vibrate by an ultrasonic sonotrode and the connection element is welded to the remaining part of the plastic component; a section that replaces the separated section is provided, wherein the replacing section has a hole, in particular a through hole; the replacing section is mounted in the region from which the separated section was separated, such that: the replacing section is clamped directly onto the connection element with form fit and/or force fit; and/or the connection element extends through the through hole by at least a certain amount, wherein a clip element is clipped onto a section of the connection element that extends through the hole, wherein the clip element projects above the through hole and connects the replacing section to the remaining part of the plastic component with form fit and/or force fit.

The starting point of the invention is a method for exchanging a section, in particular a damaged section, of a plastic component. The plastic component may be, for example, a bodywork component of a vehicle, in particular a fiber-reinforced plastic component such as a plastic component reinforced with carbon fiber and/or a plastic component reinforced with glass fiber or by other fibers.

In a first step, the said section (for example the damaged section) is separated from the plastic component. Here, it may be provided for the plastic component to have severing points that are pre-defined at the factory by the manufacturer, that is to say are already pre-defined in the undamaged condition, at which the separating off is preferably performed. The separating off may, for example, be performed by cutting (for example water jet cutting, or cutting by means of a high-energy beam (laser beam)) or in another way.

Once the section has been separated from the plastic component, a connection element, which is likewise made from a plastic material, is provided and pressed against the first component. The connection element thus comes to bear against a remaining part of the plastic component. It is then made to vibrate by way of an ultrasonic sonotrode and is welded to the remaining part of the plastic component.

Preferably, the plastic component and/or the connection element is a plastic component or connection element made from a thermoplastic. At the least, the connection element should be made from a thermoplastic material in the region in which it is welded to the plastic component.

Accordingly, the plastic component should be made from a thermoplastic material at least in the region in which it is welded to the connection element. For the purpose of welding the connection element to the plastic component, the connection element may be made to vibrate in a translational motion and/or in a rotary motion by way of the ultrasonic sonotrode, which has the effect that material of the connection element and/or material of the plastic component melts in the contact region of the connection element.

According to the invention, a section that replaces the separated section is provided, wherein the replacing section has a hole, for example a through hole.

Then, the replacing section is mounted in the region from which the separated section was separated, such that the connection element extends into the hole by at least a certain amount or extends through the through hole by at least a certain amount.

The replacing section may optionally be clamped directly onto the connection element with form fit and/or force fit, by means of its hole or through hole, for which it is necessary for the replacing section to be undersized to a certain extent in relation to the connection element in the region of the hole or through hole, and to have at least a certain elasticity so that the hole or through hole can be clamped onto the connection element.

As an alternative, it may be provided for the connection element to extend through the through hole by at least a certain amount and for a clip element to be clipped onto the section that extends through the through hole, wherein the clip element projects above the through hole and consequently connects the replacing section to the remaining part of the plastic component with form fit and/or force fit.

Although the invention has been described only in the context of one connection element, it will be appreciated that the replacing component may also be connected by way of a plurality of connection elements that are connected to the plastic component in a like or similar manner.

According to a further development of the invention, the replacing section is glued to the remaining part of the plastic component. It may be provided for the replacing section to project above the remaining part of the plastic component by at least a certain amount, wherein an adhesive is inserted between the replacing section and the remaining part of the plastic component and is used to glue the replacing section to the remaining part of the plastic component.

In principle, the replacing section could be connected to the remaining part of the plastic component only by way of one or more connection elements and where required a respective clip element that is clipped onto each of these. Specifically in vehicle bodywork construction, however, it is important for a damaged section that is to be replaced to be connected to the remaining part of the plastic component such that the “repaired plastic component” as far as possible has the same strength as the original plastic component. Thus, in many or in most cases, gluing the replacing section to the remaining part of the plastic component will probably be necessary.

According to a further development of the invention, the plastic component has a physical mark, for example a recess in the form of a hollow, or it may be provided for a physical mark of this kind to be made at the point on the plastic component at which the connection element is to be welded to the plastic component. The physical mark is provided for the purpose of enabling the connection element to be precisely positioned in a simple manner.

According to a further development of the invention, a connection element that has at least one ball, or is formed by at least one ball, is used. The connection element may for example be a “double ball”, that is to say be formed by two mutually connected balls, for example two balls that are welded to one another. In this case, initially one of the balls may be welded to the remaining part of the plastic component. In a succeeding step, a further ball may be welded onto the already welded-on ball. As an alternative thereto, a connection element comprising two or more balls may already be used, and this may be welded onto the remaining part of the plastic component.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an individual step for exchanging a section of a plastic component.

FIG. 2 shows an individual step for exchanging a section of a plastic component.

FIG. 3 shows an individual step for exchanging a section of a plastic component.

### DETAILED DESCRIPTION OF THE DRAWINGS

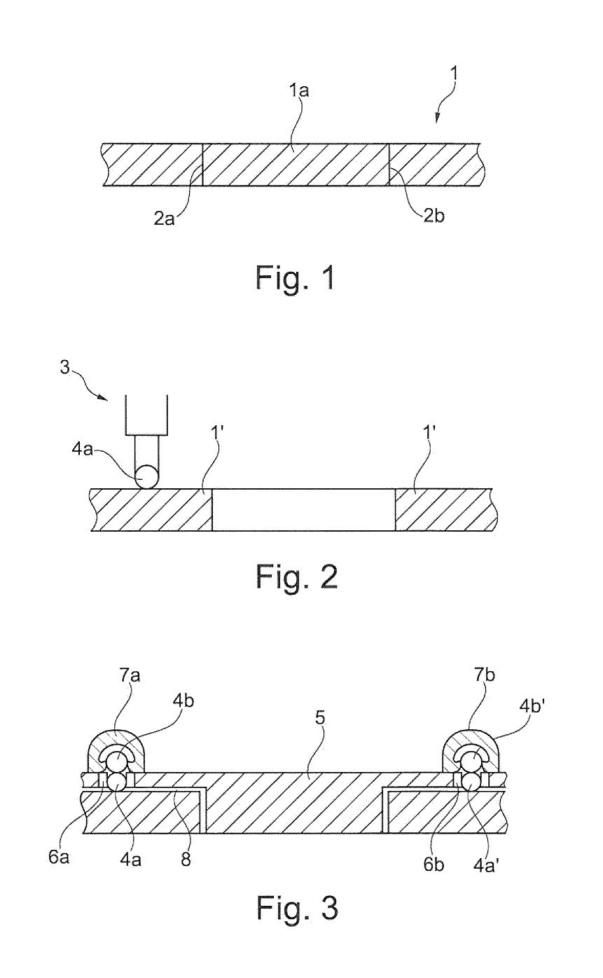

FIG. 1 shows a plastic component 1, which may for example be a bodywork component or a bodywork structural component of a vehicle. It is possible for pre-defined severing points 2a, 2b in or on the plastic component 1, at which the plastic component 1 can be separated off, already to be provided at the factory. The separating off may, for example, be performed by cutting, sawing or in another manner.

In a manner not illustrated in more detail here, a section la of the plastic component that is located between the two severing points 2a, 2b is separated. After it has been separated, a remaining part 1′ of the plastic component 1 remains (see FIG. 2).

A plastic ball 4a made from plastic material is welded to the remaining part 1′ of the plastic component 1 by use of a sonotrode 3. A further ball 4b is then welded to the ball 4a (cf. FIG. 3). The two balls 4a, 4b form a double ball that “acts as a connection element”.

In the same way, a double ball 4a′, 4b′ is welded on at the opposite side of the remaining part 1′ of the plastic component 1 by use of a sonotrode.

Then, a replacing section 5 is provided. The replacing section 5 may, for example, be likewise a plastic component, or a component made from another material. The replacing section 5 has two through holes 6a, 6b.

The replacing section 5 is arranged such that the connection elements that are formed by the two double balls 4a, 4b and 4a′, 4b′ project into or partly through the through holes 6a, 6b. Provided the two double balls 4a, 4b and 4a′, 4b′ are oversized in relation to the through holes 6a, 6b and the replacing component 5 has a certain elasticity in the region of the through holes 6a, 6b, the replacing component 5 can be clamped to the double balls 4a, 4b and 4a′, 4b′ directly by way of its through holes 6a, 6b.

As can be seen from FIG. 3, the upper balls 4b and 4b′ each project by at least a certain amount out of the through holes 6a, 6b. As an alternative or in addition to the above-described direct clamping, it is possible for a respective clip element 7a or 7b to be clipped onto the projecting part of the connection elements, that is to say to the upper balls 4b, 4b′, and for the replacing section to be connected in this way to the remaining part 1′ with form fit and/or a force fit.

Before the replacing section 5 is placed on the remaining part 1′, it is possible for a layer 8 of adhesive to be inserted between the replacing section 5 and the remaining part of the plastic component 1, by which the replacing section 5 is glued to the remaining part 1′. As a result of the clipped-on clip elements 7a, 7b and/or the direct clamping of the replacing section 5, it is ensured that the replacing section 5 is fixed sufficiently reliably and firmly to the remaining section 1 and thus the adhesive 8 is able to cure properly.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for exchanging a section of a plastic component, the method comprising the acts of:
separating a section from the plastic component;
providing at least one connection element made from a plastic;
pressing the at least one connection element against the plastic component such that the connection element comes to bear against a remaining part of the plastic component;
causing the connection element to vibrate via an ultrasonic sonotrode so as to weld the connection element to the remaining part of the plastic component;
providing a replacing section that replaces the section separated from the plastic component, the replacing section having a hole;
mounting the replacing section in a region from which the separated section was separated, wherein the mounting of the replacing section is carried out by one or both of:
(i) clamping the replacing section directly onto the connection element with a form and/or force fit, or
(i) extending the connection element through the hole in the replacing section by at least a defined amount, wherein a clip element is clipped onto a section of the connection element that extends through the hole, the clip element projecting above the hole and connecting the replacing section to the remaining part of the plastic component with a form and/or force fit.

2. The method as claimed in claim 1, wherein
the replacing section projects above the remaining part of the plastic component by at least a defined amount, wherein an adhesive is inserted between the replacing section and the remaining part of the plastic component and is used to adhere the replacing section to the remaining part of the plastic component.

3. The method as claimed in claim 1, wherein
the remaining part of the plastic component has a physical mark, and
the connection element is positioned in relation to the remaining part by way of the physical mark.

4. The method as claimed in claim 1, wherein the physical mark is a hollow recess.

5. The method as claimed in claim 3, wherein
the physical mark is made on the remaining part at a point at which the connection element is to be welded to the remaining part.

6. The method as claimed in claim 1, wherein the connection element has at least one ball.

7. The method as claimed in claim 1, wherein the plastic component is a fiber-reinforced plastic component.

8. The method as claimed in claim 7, wherein
the fiber-reinforced plastic component is a carbon and and/or glass fiber-reinforced plastic component.

9. The method as claimed in claim 1, wherein
the plastic component has pre-defined severing points and is separated precisely at the pre-defined severing points.

10. The method as claimed in claim 1, wherein
the plastic component is a bodywork component of a vehicle.

11. The method as claimed in claim 1, wherein
the connection element is made from a thermoplastic material at least in the region in which it is welded to the remaining part.

12. The method as claimed in claim 1, wherein
the plastic component is made from a thermoplastic material at least in the region of the remaining part in which it is welded to the connection element.

13. The method as claimed in claim 1, wherein
the connection element is made to vibrate in a translational motion by way of the ultrasonic sonotrode.

14. The method as claimed in claim 1, wherein
the connection element is made to vibrate in a rotary motion by way of the ultrasonic sonotrode.

15. The method as claimed in claim 1, wherein
the section separated from the plastic component is a damaged section of the plastic component.

16. The method as claimed in claim 1, wherein the hole in the replacing section is a through-hole.
